(19) United States
(12) Patent Application Publication
(10) Pub. No.: US 2003/0018613 A1
(43) Pub. Date: Jan. 23, 2003

(54) Privacy-protecting user tracking and targeted marketing

(76) Inventor: Engin Oytac, Istanbul (TR)

Correspondence Address: PERKINS COIE LLP, PATENT-SEA, P.O. BOX 1247, SEATTLE, WA, 98111-1247, US

(21) Appl. No.: 10/131,580

(22) Filed: Apr. 24, 2002

Related U.S. Application Data
(63) Continuation-in-part of application No. 09/919,765, filed on Jul. 31, 2001, now abandoned.
(60) Provisional application No. 60/221,774, filed on Jul. 31, 2000.

(51) Int. Cl. G06F 7/00

(52) U.S. Cl. 707/1

(57) ABSTRACT

A method, system, and computer-readable medium for assisting in targeting information to users while protecting the privacy of those users is described. Various transaction and/or other user-specific information may first be obtained from one or more of a variety of information sources, and can then be provided to user targeters that desire to target information to other users that match specified criteria. Information about the matching users is provided to the user targeters in a manner that obscures the identity of those users. After a user targeter selects identity-obscured users to which targeted information is to be provided, the information is provided to those targeted users in various ways. In some situations, the targeted information is marketing information such as an advertisement and/or information about a discount or other promotional benefit that is available, and is provided to users at a POS location.

### CROSS REFERENCE TO RELATED APPLICATIONS

This application is a continuation-in-part of U.S. patent application Ser. No. 09/919,765 (Attorney Docket #344918001US1), filed Jul. 31, 2001 and entitled “Privacy Preserving Marketing Strategy,” which is hereby incorporated by reference in its entirety and which claims the benefit of U.S. Provisional Application No. 60/221,774, filed Jul. 31, 2000 and also incorporated herein by reference in its entirety.

### TECHNICAL FIELD

The following disclosure relates generally to providing information to users, and more particularly to providing targeted information to users in a manner that protects the privacy of the users, such as when providing targeted marketing information to users at a point-of-sale in a retailer's store.

### BACKGROUND

Companies and individuals that desire to provide information and/or opportunities (e.g., a discount or other type of promotional benefit) to others have significant incentives to limit distribution to recipients that are likely to use or otherwise benefit from those opportunities or information, such as to limit the cost of the distribution, to avoid unhappiness of recipients that do not wish to receive the distribution, to avoid violating legal prohibitions, etc. Similarly, individuals and organizations have significant incentives to limit the information that they receive so that the received information represents information and opportunities that they are likely to use or otherwise benefit from, such as to minimize the time and cost involved with receiving and managing undesired and useless information.

One significant problem that inhibits this mutually beneficial targeting of information and opportunities to appropriate recipients is that many individuals and organizations desire to protect their privacy, such as to prevent their identity from being revealed or otherwise detectable during a transaction (e.g., involving an item, such as a product or service, that is for sale, purchase, rent, lease, license, trade, evaluation, sampling, etc.) or to prevent their identity from being associated with transaction history information about previous transactions that is made available to third-parties that are not trusted. Similarly, such potential recipients may desire to protect their privacy by preventing various types of sensitive information from being made available to third-parties and from preventing their identity from being revealed or otherwise detectable when making various non-transaction information (e.g., demographic information, such as geographic location, age range, occupation, education level, marital status, gender, ethnic background, annual income, etc.) available to third-parties. Such potential recipients' desire to protect their privacy may also be reinforced in some situations by legal restrictions that enforce such privacy protections, whether on a uniform basis for all potential recipients or on a recipient-specific basis (e.g., based on preferences of those recipients).

Unfortunately, useful techniques are not typically available to make such information about potential recipients available to third-parties in a way that protects the privacy of the potential recipients while allowing the third-parties to effectively target information and opportunities to appropriate recipients. Accordingly, a need exists for more effective techniques for such sharing of information.

### BRIEF DESCRIPTION OF THE DRAWINGS

FIG. 1 illustrates examples of the use of the disclosed techniques for targeting information to recipients while protecting the privacy of those recipients.

FIG. 2 is a network diagram illustrating various devices and entities that interact in one embodiment of the disclosed system for targeting information to recipients while protecting the privacy of those recipients.

FIG. 3 is a block diagram illustrating an embodiment of a system for targeting information to recipients while protecting the privacy of those recipients.

FIG. 4 is an example user interface screen of a device at a point-of-sale location for targeting information to consumers participating in transactions.

FIG. 5 is a flow diagram of an embodiment of the Information Collector routine.

FIG. 6 is a flow diagram of an embodiment of the Identify-Obscured User Information Provider routine.

FIG. 7 is a flow diagram of an embodiment of the Targeted Information Receiver routine.

FIG. 8 is a flow diagram of an embodiment of the Targeted Information Provider routine.

FIG. 9 is a flow diagram of an embodiment of the Registered Account Information Provider routine.

FIG. 10 is a flow diagram of an embodiment of the Targeted Marketing And/Or Tracking Device routine.

### DETAILED DESCRIPTION

A software facility is described below that assists in targeting information to recipients while protecting the privacy of those recipients. In particular, the privacy-protecting information targeting techniques include obtaining various transaction and/or other recipient-specific information from one or more of a variety of information sources (also referred to herein as “Information Providers”), and providing information to individuals or organizations that desire to target information to other individuals or organizations (referred to herein as “users”) that match specified criteria. The information is provided to the individuals or organizations that desire to target information (also referred to herein as “user targeters” or “Information Users”) about the matching users in a manner that obscures the identity of those users, and in some embodiments additional types of sensitive information about users may also be obscured. After a user targeter selects identity-obscured users to which targeted information is to be provided, the information is provided to those targeted users in various ways.

In some embodiments, the facility is used to provide targeted marketing to users at a Point-Of-Sale (“POS”) location, such as in a retailer's store. In such embodiments, the received information is marketing information such as an advertisement to be displayed and/or information about a discount or other promotional benefit that is available. When a targeted user is engaged in a transaction at a POS location of a retailer (referred to in such embodiments as a “transaction retailer”), information about the user and/or the transaction is provided to the facility. Information targeted to that user, such as by an unrelated retailer user targeter (referred to in such embodiments as a “targeting retailer”) for an unrelated transaction with that retailer in which the targeted user may participate in the future, can then be provided to the user on a device at the POS.

The facility can also assist in providing targeted promotional benefits to targeted users. For example, when the facility receives information about a current transaction involving a user, the facility can determine whether a promotional benefit related to the current transaction has been targeted to the user, and if so the facility can provide information about the targeted benefit to a device or system involved in processing the current transaction so that the targeted benefit can be provided. In some embodiments, the facility provides payment processing capabilities for various retailers, and in those embodiments the facility can provide targeted benefits such as discounts before processing payment.

Information about users can be obtained by the facility in a variety of ways. In some embodiments, the facility directly receives transaction information for users from retailers involved in those transactions, such as from retailers that have joined a network of retailers sponsored by the facility (e.g., an affiliate network that includes various transaction retailers and/or targeting retailers) and/or that are willing to sell transaction information. In addition, in some embodiments the facility may receive various non-transaction information about users directly from those users, such as when those users have registered with a service associated with the facility and/or are willing to sell their information or purchase the ability to receive targeted information. The facility may also receive transaction information indirectly from third-parties to those transactions and receive user information indirectly from third-parties others than those users. For example, information about transactions and users is compiled and/or stored by various organizations (e.g., credit card and other payment type processors, credit card and other payment type issuers, banks and other financial institutions, hospitals, governmental agencies, etc.), some of which may provide the information to others for a fee and/or upon receiving permission of the users.

The facility may protect users' privacy in various ways. In some embodiments, any information about a user's identity or that could be used to directly contact the user (e.g., home or business address, phone number, email address, etc.) is removed or otherwise obscured before the information is provided to user targeters. In other embodiments, information about individual users is not provided, and instead aggregate information about groups of multiple users is instead provided. In addition, specified types of information may be removed or otherwise obscured before it is provided to user targeters, such as in a uniform manner, in a manner specific to particular users (e.g., in accordance with instructions received from those users and/or a level of privacy protection purchased by or from those users), and/or in a manner specific to the user targeters (e.g., based on instructions from those user targeters and/or a level of user information access purchased by those user targeters).

In various embodiments, payments can be made between various entities for the various services provided. For example, user targeters may provide payment for access to identity-obscured user information and/or for the targeting of information to users. In addition, information providers, whether the users themselves or third-parties, may be paid for providing information (e.g., 60% of the fee paid by a user targeter to receive user information, which may for example be one-third of the total fee paid by a user targeter to have a targeting campaign be provided) and/or for providing permission to use information. Users may be paid for allowing themselves to received targeted promotions, or instead may make payment in order to receive such targeted promotions. Entities that provide a location for presenting or otherwise providing targeted promotions or other information, such as a POS location at a retailer, may receive payment for allowing the providing of the targeted information (e.g., 15% of the fee paid by a user targeter to provide targeted information to targeted users, which may for example be two-thirds of the total fee paid by a user targeter to have a targeting campaign be provided), or may instead in some situations make payment to receive such promotions. The provider of a privacy-protecting service based on the functionality provided by the facility may also receive payment for facilitating the targeting of information to targeted users in a manner that protects their privacy (e.g., 40% of the fee paid by a user targeter to receive user information and 85% of the fee paid by a user targeter to provide targeted information to targeted users, or 70% of the total fee paid by a user targeter to have a targeting campaign provided). Other information about payment arrangements is discussed below.

For illustrative purposes, some embodiments of the software facility are described below in which the targeted information is marketing information and in which the targeted marketing information and the resulting promotional benefits are provided to users by sending information to devices at retailers' POS locations. However, those skilled in the art will appreciate that the techniques of the invention can be used in a wide variety of other situations, and that the invention is not limited to these illustrated embodiments. In addition, in some embodiments the software facility could also provide a variety of other related functionality or services, such as a spam-limiting service that assists users (e.g., registered users) in limiting or eliminating the receipt of information or promotions from some or all sources other than those associated with the software facility (e.g., by adding the users' names to “Do Not Call” lists of direct marketers using email, telephone, postal mail, etc.), such as for a fee.

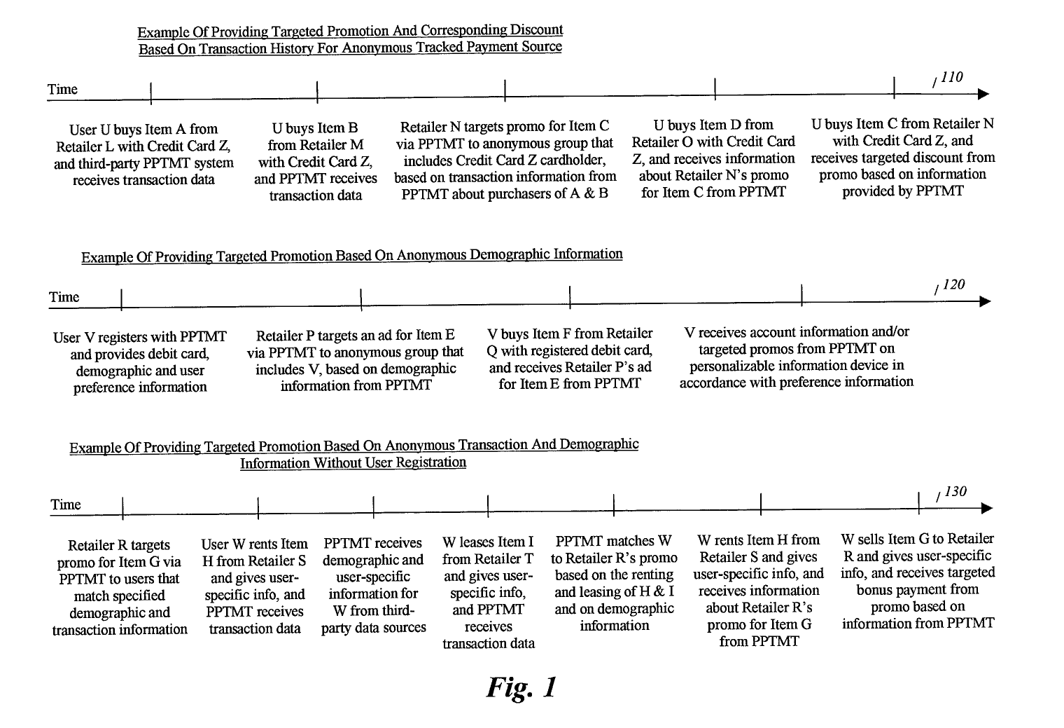

As an illustrative example of the use of a Privacy-Protecting Targeted Marketing and Tracking (“PPTMT”) system facility that assists in targeting marketing information and resulting promotional benefits to users while protecting the privacy of those users, consider three targeted marketing examples illustrated in FIG. 1.

The first example, shown with respect to timeline 110, illustrates an example of targeting a promotion to a user based merely on the transaction history of the user and without knowledge of the identity of the user by the PPTMT system or the user targeter. In particular, in the illustrated example User U buys a first item from a first retailer using a credit card issued to U, and the retailer or credit card payment processor provides information to the PPTMT system about the transaction that includes the credit card number but no other identifying information about U. U later buys a different item from a different retailer using that same credit card, and the PPTMT system again receives transaction data for that transaction that includes the credit card number. The PPTMT system is able to associate those two purchases together based on the use of that credit card, and to use that unique credit card number as identification tracking information for User U without knowing the identify of U.

At a later time, a third retailer decides to target a new promotion for yet another item to users that match a specified criteria (e.g., purchasing Item B and any of a group of items that include Item A within the last week), and the purchase of the two previous items by U matches the criteria. The user targeter Retailer N may first view various identity-obscured information about one or more users that match the specified criteria and/or other criteria, or may instead merely specify the criteria. Retailer N provides details about the targeted marketing promotion to the PPTMT system, such as an ad to be displayed and a discount to be provided. At a later time, U buys a fourth item from another retailer using the same credit card, and the PPTMT system receives information about the transaction from a device at the POS. The system identifies that the holder of the credit card being used is to receive the targeted marketing promotion for Item C from Retailer N (still without knowing that the card holder is U), and provides information to U about the promotion at the POS at the time of purchase (e.g., by displaying the ad on a display of the device at the POS and/or printing out a coupon indicating the discount).

When U later buys Item C from Retailer N using that same credit card, the PPTMT system recognizes that the holder of that credit card is to receive the targeted marketing promotion, and sends information to a device at the Retailer N POS to ensure that any corresponding discounts or other promotional benefits are provided to U at the time of purchase. Thus, in this way U can receive a targeted marketing promotion without any of the retailers L-O or the PPTMT system ever knowing the identify of U or any other non-transactional information about U.

The second example in FIG. 1 is illustrated with respect to timeline 120, and provides an example of providing targeted content to a user based on their demographic information without the targeting retailer knowing the identity of the user. In particular, in this illustrated example the PPTMT system first obtains demographic and debit card information for a User B directly from B when B registers with the PPTMT system, although in other situations such information could be obtained from one or more third-party sources of information. At some point after B registers with the PPTMT system, a retailer P targets an advertisement for Item E to a group of one or more identity-obscured users that match specified demographic information criteria, with the targeted group in this example including B. When B later buys another item from another retailer and provides information with which the PPTMT system can identify B (e.g., use of one or more registered debit cards and/or providing of a unique registered user ID), the PPTMT system provides the targeted ad for presentation to B at the POS. B chooses to not receive the benefits of the promotion at this time. As a registered user, however, B does later access the PPTMT system (e.g., from a home computer or publicly accessible kiosk) to view his/her account information and/or to receive additional targeted promotions, with the information provided in a manner in accordance with preference information supplied at the time of registration.

In the third example illustrated in FIG. 1, shown with respect to timeline 130, a User W qualifies for a targeted promotion based on a combination of transaction and demographic information for W that is received by the PPTMT system after the targeted promotion criteria have been specified. In particular, a Retailer R targets a promotion for Item G to users that match specified criteria including demographic and transaction information. At a later time, W rents Item H from another retailer and supplies some type of user-specific information that distinguishes the user from others (e.g., phone number, social security number, etc.), and the PPTMT system receives the transaction data and user-supplied information. The PPTMT system later receives demographic information and other user-specific information for multiple users that include W from a third-party information source, with the user-specific information for W including the information supplied by W when renting Item H, but the PPTMT system does not receive information about the identities of the multiple users. W later leases an Item I from yet another retailer and supplies user-specific information that was included in the information about W from the third-party data source (e.g., different user-specific information than was supplied by W when renting Item H), and the PPTMT system again receives the transactional data.

After receiving this various information and correlating the demographic information and the transactional information for the two transactions based on the various user-specific information for W, the PPTMT system identifies W (without knowing W's identity) as matching the targeted promotion. Thus, when W later again rents the same Item H from the same retailer S as in the first transaction and again supplies user-specific information for W that the PPTMT system is aware of (whether the same or different from the user-specific information supplied in the first transaction), the PPTMT system identifies W as a targeted recipient for the promotion and thus provides information to W about that promotion. When W later performs a corresponding transaction with Retailer R that matches the promotion, the PPTMT system recognizes that W is to receive the benefits of the targeted promotion and provides information to Retailer R to ensure that those benefits are provided.

Thus, the PPTMT system can use various techniques to track users and to provide targeted benefits to those users in a manner that protects their privacy.

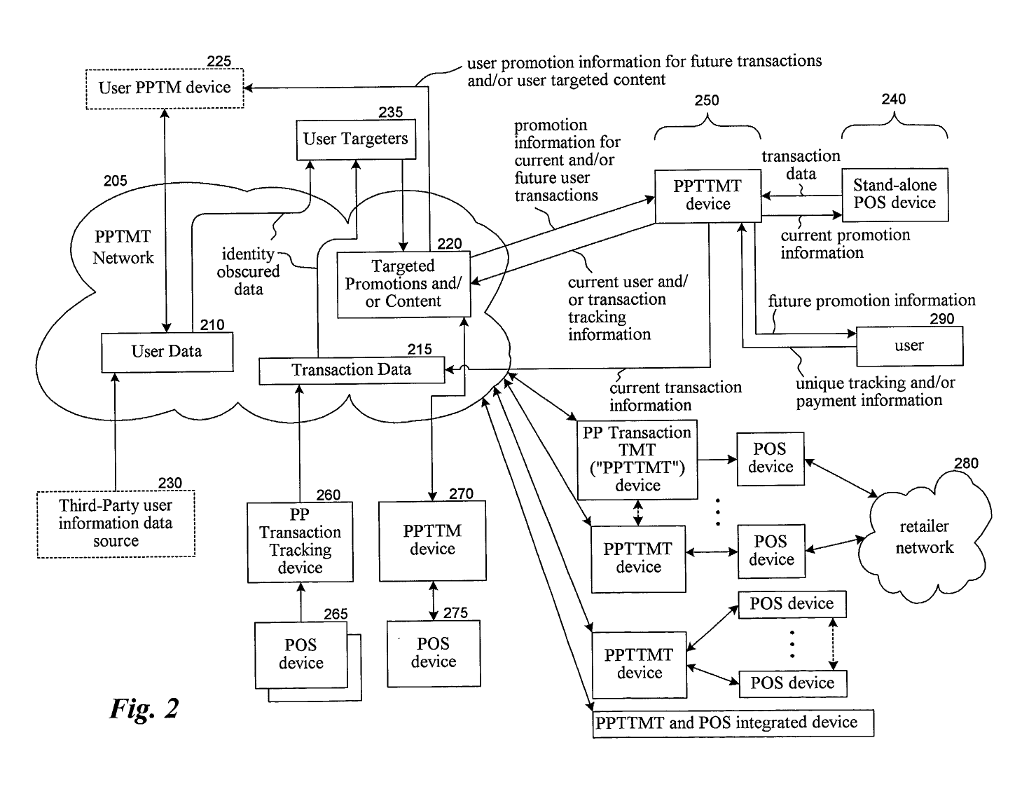

FIG. 2 is a network diagram illustrating various devices and entities that interact in one embodiment of the PPTMT system. In this example embodiment, a PPTMT network 205 having one or more servers stores various transaction data 215 and user data 210, and provides that information in an identity-obscured fashion to user targeters 235. The user targeters can then select groups of one or more anonymous users to receive various targeted promotions and/or targeted content 220. As shown, the PPTMT network can receive the user and transaction data from various sources, such as receiving user data from the users themselves via devices 225 used by the users and/or from third-party user information data sources 230. Transaction data can also be provided by third-party transaction tracking devices 260 that are associated with the PPTMT system, whether in real-time or in periodic batches. In the illustrated embodiment the transaction tracking devices 260 are linked to POS devices 265 from which they receive at least some of the transaction information.

The PPTMT network in this example embodiment can also receive transaction data from various PPTMT-associated devices 250 each in communication with at least one corresponding POS device 240. These privacy-protecting transaction targeted marketing and tracking (or “PPTTMT”) devices both provide transaction information to the PPTMT system for tracking purposes and receive promotion information to be applied to current transaction and/or provided to the user for use in possible future transactions. In particular, the PPTTMT devices receive transaction data from their corresponding POS devices, and send that transaction data to the PPTMT network for use in later targeting of marketing information. These example PPTTMT devices also supply information to the PPTMT network to identify information about any targeted promotions to be applied to a current transaction and to receive targeted promotions to be presented to a current user for possible use in future transactions. Thus, if the transaction data is sufficient to identify the current user (e.g., from a credit card or other user-specific payment information used as part of the transaction), no other user-specific information may be supplied, or instead various non-transaction user information (e.g., a user ID or credit card information for a credit card that is not being used as part of the current transaction) may additionally be supplied. In other embodiments, users may be identified in other manners, such as using various biometric identification techniques and/or performing signature recognition of a user's signature (e.g., from a credit card authorization signature).

In this example embodiment, promotion information for the current transaction can be based on the current user and/or the current transaction (e.g., based on a promotion previously targeted to the current user for this or any transaction from the current retailer, and/or based on a promotion previously targeted to any user involved in a type of transaction of which the current transaction is an example), while the promotion information for future transactions is based only on the current user without regard to the current transaction or the current retailer. As is shown, the PPTTMT devices and their corresponding POS devices can have various configurations, such as one-to-one or one-to-many relationships, and POS devices can be stand-alone or networked together. For example, some of the POS devices are linked together as part of a retailer network 280 (e.g., with other computing devices of that retailer), such as POS devices at multiple physical locations.

In addition to the PPTTMT devices that provide transaction information for tracking purposes, receive promotion information to be applied to current transactions, and receive promotion information to be provided to the user for future transactions, the PPTMT network in this example embodiment can also include associated devices that perform only one of these three functions. For example, some dedicated PP transaction targeted marketing devices 270 may receive use promotion information for a current transaction, but not provide transaction data for tracking to the PPTMT network or present targeted promotion information for future transactions. Conversely, some PP targeted marketing devices that are not associated with POS devices may receive and present targeted promotion information for future transactions, but not provide information about current transactions (if any) or receive promotion information to be applied to current transactions. As previously noted, transaction tracking devices 260 that are associated with the PPTMT system may provide transaction data for tracking to the PPTMT network, but not receive promotion information for current or future transactions.

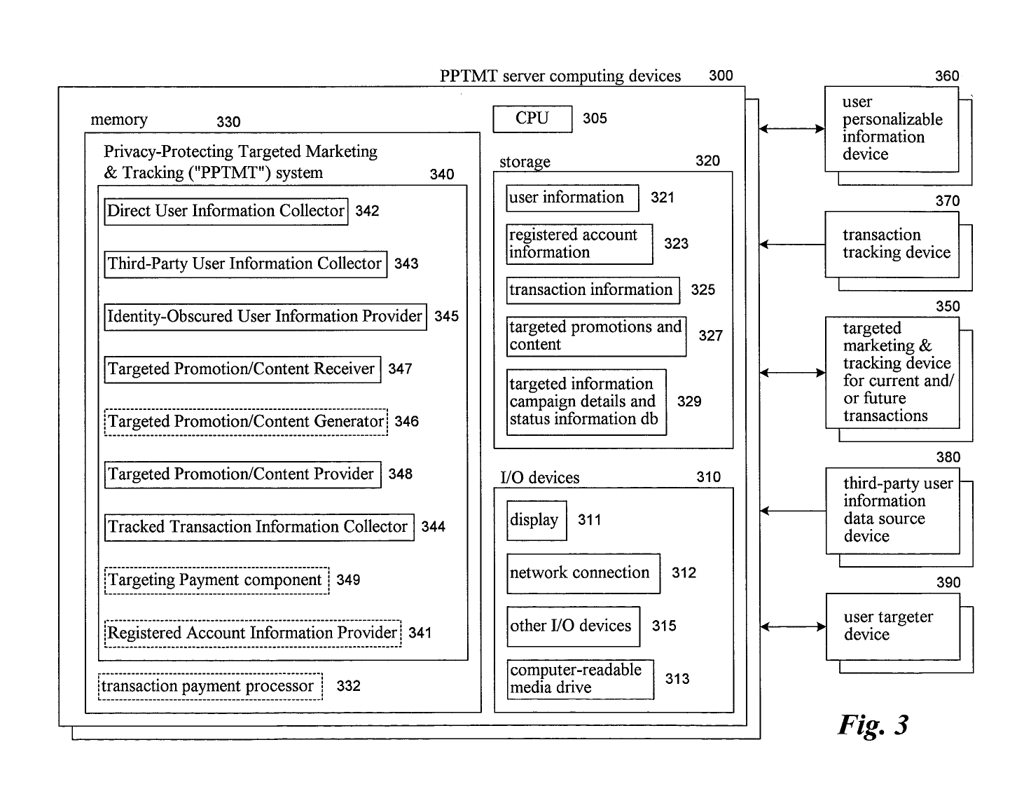

FIG. 3 is a block diagram illustrating one or more PPTMT server computing devices 300 that are part of the PPTMT network and are suitable for executing an embodiment of the PPTMT system, either alone or in combination. The PPTMT server computing devices are also able to communicate with various remote devices 350-390, as described in greater detail below. The devices can interact in various ways, such as over a dedicated local area network, over the Internet and/or the World Wide Web, over a secure extranet, etc.

Each server computing device 300 includes a CPU 305, various I/O devices 310, storage 320, and memory 330. The I/O devices include a display 311, a network connection 312, a computer-readable media drive 313, and various other I/O devices 315. An embodiment of the PPTMT system 340 is executing in memory, and it includes various components 341-349.

The PPTMT system components include a Direct User Information Collector component 342 and a Third-Party User Information Collector component 343. These components interact with users and third-party information data sources respectively to obtain user information for use in targeting appropriate content and promotions to those users. To receive user information, the Direct User Information Collector component interacts with a variety of information devices 360 which can present user-personalized information and from which users can supply information, such as personal computers, publicly accessible kiosks, cell phones, interactive TVs, etc. Similarly, the Third-Party User Information Collector component interacts with various third-party user information data source devices 380 or information services or storage (not shown) to retrieve user information. In the illustrated embodiment, the collected user information is stored in a user information database 321 data structure on storage, although in other embodiments such information could be stored in other manners (e.g., remotely or in a distributed manner), or could instead be dynamically retrieved from appropriate information sources when needed.

While in some embodiments users and/or third-party user information data sources may be able to interact with the PPTMT system without having established a prior relationship with the system, in other embodiments such entities will first establish such a relationship. Thus, an optional Registered Account Information Provider component 341 is also illustrated in memory, and it can similarly interact with the user and third-party devices 360 and 380 to establish relationships and to provide information about corresponding accounts and relationships. A variety of other types of entities may similarly have established relationships and thus also be able to interact with the Registered Account Information Provider component, including user targeters (e.g., retailers) via user targeter devices 390, retailers or others willing to provide transaction data (not shown), retailers or others willing to receive and apply information about their own promotions for current transactions (not shown), and retailers or others willing to receive and provide promotion information for future transactions from themselves and/or other user targeters (also not shown). In the illustrated embodiment, the Registered Account Information Provider component stores various information about the registered entities in a registered account information database 323 on storage, although in other embodiments different databases may be used for each type of entity and/or the account information may be stored in other manners.

In a manner similar to the information collector components, the Tracked Transaction Information Collector component 344 obtains information about transactions by users for use in targeting promotions and content to those users. In the illustrated embodiment, the component interacts with both third-party transaction tracking devices 370 and dedicated targeted marketing and tracking devices 350 in order to receive transaction information, and stores such information in the transaction information database 325 on storage. As with the user information, in other embodiments the transaction information may be stored in other manners and/or retrieved dynamically when needed.

The Identity-Obscured User Information Provider component 345 receives requests from user targeters to provide information about users that match specified criteria, and provides the information to those user targeters in a manner that protects the identity and/or privacy of the users. In particular, the component may retrieve user information and/or transaction information from the databases 321 and 325, obscure the identity of corresponding users in the retrieved information in various ways, and then provide the identity-obscured information to the requesting user targeters.

After a user targeter selects a promotion and/or content to be targeted to a group of one or more users, the user targeter provides that information to the Targeted Promotion/Content Receiver component 347. The component 347 stores copies of the targeted information in a database 327 on storage, although in other embodiments may retrieve such information from the user targeters and/or other accessible sources when needed. The component 347 also stores information about a targeting campaign (e.g., users to be targeted, the number of times and the frequency with which the targeted users are to receive the targeted information, the length of the targeting campaign etc.) specified by the user targeter in a targeted information campaign database 329 on storage. In some embodiments, an optional Targeted Promotion/Content Generator component 346 may also be available to generate the targeted promotions or content for users, such as interactively in a manner controlled by the user targeters or instead in an automated manner.

After one or more targeting campaigns have been defined, the Targeted Promotion/Content Provider component 348 identifies when information received for current transactions and/or currently accessible users matches those defined campaigns, and provides the targeted information for those campaigns as appropriate. For example, the targeted marketing and tracking devices 350 may indicate information about a current transaction and/or a current user, and the component 348 may identify information about targeted promotional benefits to be provided as part of the current transaction and provide that information to those devices. Similarly, the component 348 may identify information to be provided to a current user about promotions for future transactions, and if so can provide that information to the targeted marketing and tracking device for presentation to the user. Such user-specific targeted information can also be provided to users when they are accessible to the system in other manners, such as via a user personalizable information device 360. After targeted promotions or content are provided to users or applied to current transactions, the campaign database 329 is updated to reflect the current status. In other embodiments, separate databases may be used to store campaign details and campaign status information.

The illustrated system also includes an optional Targeting Payment component 349. In the illustrated embodiment, the component can interact with any of the other system components to provide and/or obtain payment for any of the activities performed by the other components, with such payments being obtained from or provided to any of the various devices or entities previously mentioned.

In addition to the PPTMT system, an optional transaction payment processor module 332 is also executing in memory. In embodiments in which targeted marketing devices receive payment information directly from users or indirectly from POS devices, one or more of the PPTMT servers may also provide the service of processing payment for a corresponding transaction, either for an associated POS device and/or for transactions conducted solely over the targeted marketing device.

Those skilled in the art will appreciate that computing devices 300, 350, 360, 370, 380 and 390 are merely illustrative and are not intended to limit the scope of the present invention. In particular, any of the “devices” may comprise any combination of hardware or software that can interact in the described manners, including computers, network devices, internet appliances, PDAs, wireless phones, pagers, electronic organizers, television-based systems and various other consumer products that include inter-communication capabilities. Computing device 300 may also be connected to other devices that are not illustrated, including through one or more networks such as the Internet or via the World Wide Web (WWW). In addition, the functionality provided by the illustrated system components may in some embodiments be combined in fewer components or distributed in additional components. Similarly, in some embodiments the functionality of some of the illustrated components may not be provided and/or other additional functionality may be available.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software modules and/or components may execute in memory on another device and communicate with the illustrated computing device via inter-computer communication. Some or all of the system components or data structures may also be stored (e.g., as instructions or structured data) on a computer-readable medium, such as a hard disk, a memory, a network, or a portable article to be read by an appropriate drive. The system components and data structures can also be transmitted as generated data signals (e.g., as part of a carrier wave) on a variety of computer-readable transmission mediums, including wireless-based and wired/cable-based mediums. Accordingly, the present invention may be practiced with other computer system configurations.

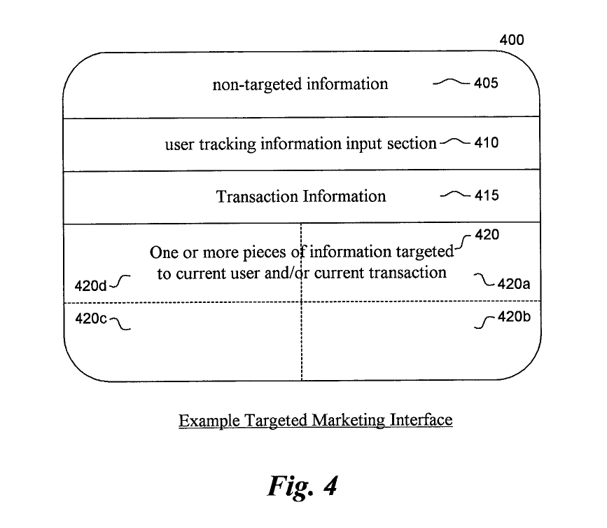

FIG. 4 provides an example of one graphical user interface that may be used to provide targeted information to users at a transaction POS, such as on a dedicated targeted marketing and tracking device at the POS. In this example, the device display screen 400 includes various sections 405-420 that can each present different types of information, although those skilled in the art will appreciate that in other embodiments such information can be presented in other manners, that additional types of information may be presented, and/or that illustrated types of information may not be presented.

In this example embodiment, the user interface includes a section 405 in which non-targeted information can be provided, such as branding information for the PPTMT system or a corresponding service or instead for a retailer at whose location the device resides. The user interface also includes a section 410 in this example embodiment in which the user can input information to be provided to the PPTMT system, such as a unique user ID or other information (e.g. a PIN) to assist in identifying or tracking the user. In other embodiments, the device may provide a similar information input capability but in a manner other than as part of the display, such as via a keypad or keyboard on which numeric or alphanumeric information may be provided or by transmitting the information to the device from another device accessible to the user.

The illustrated user interface also includes a section 415 in which information about a current transaction can be provided, such as prices or other information, instructions (e.g., to enter payment information), and/or information about targeted promotional benefits to be received as part of the current transaction. The user interface also includes a section 420 in which one or more pieces of targeted information can be presented based on the current user and/or other current transaction. In the illustrated embodiment, this section is divided into four subsections 420a-420d that are each able to present a distinct piece of information (e.g., a static image such as an ad, or a video or audio clip), although in other embodiments only a single piece of targeted information may be presented at a single time, the displayed non-targeted information may be replaced with targeted information when current transaction and/or current user information becomes available, and/or the types of information and the information layout may be dynamically modified based on the circumstances.

The example device and/or the interface on the device may also include a variety of other functionalities that are not illustrated, such as an ability to communicate with one or more computing devices of the user (e.g., in a wireless manner), such as to receive information to identify the user and/or to pay for the transaction or instead to provide information to the user such as targeted content or promotion details for storage on the user's device or presentation to the user on that device. In some embodiments, the device may also include an integrated or nearby printer with which to print out coupons or other targeted promotional information or targeted content.

In some embodiments, such a targeted marketing and tracking device can also be used to dynamically register users at the time of a transaction. For example, if the device includes the ability to accept payment information from the user (e.g., a slot with which to swipe magnetically encoded cards or to read smart cards or other types of computer-readable media) or receives such payment information indirectly from an associated POS device, the user interface can present the user with a selectable option to register the user and to use the available payment information for the user as a identifying tracking information, as well as optionally allow the user to provide additional information (e.g., a PIN). Even if payment information is not received by the targeted marketing and tracking device, the device could still query the user as to whether they wish to be registered as long as some information was available with which to track the user's identity, such as a unique ID or a username provided by the user. Moreover, the user interface could be designed to allow already registered users to identify themselves if the current transaction does not automatically provide identifying tracking information for the user (e.g., if the user has used a new credit card that was not previously registered or not otherwise associated with the user). Such a targeted marketing and tracking device could also be used in some embodiments to gather additional information from a user (e.g., user preferences and/or for use in targeting information to that user) and/or to obtain permission from a user (e.g., to allow targeting of information to that user and/or to allow use of certain information about that user for targeting purposes)

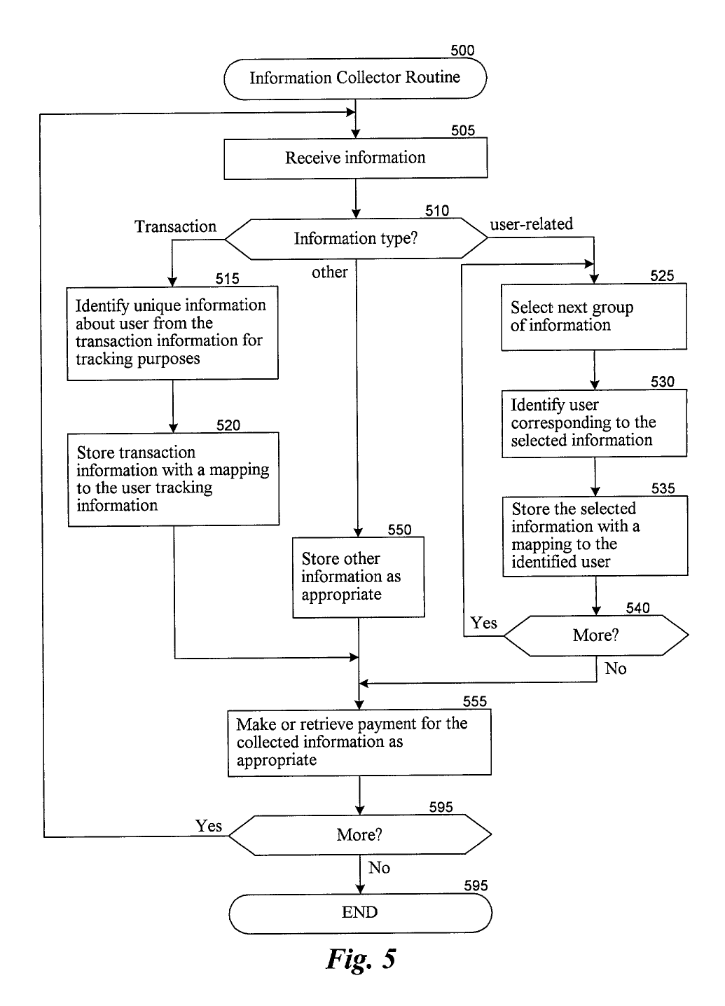

FIG. 5 is a flow diagram of an embodiment of the Information Collector Routine 500. The routine receives and stores various types of user-related and transaction information from a variety of sources, so that the information can be used for targeting purposes. The routine begins at step 505 where information is received, and in step 510 the type of the information is determined. If the information is transaction information, the routine continues to step 515 to identify unique information about the user from the transaction information for tracking purposes, such as from a credit card used to complete the transaction. After step 515, the routine continues to step 520 to store the transaction information along with a mapping to the identified user tracking information. If no user information could be identified in step 515, in some embodiments the transaction information may instead not be stored (not illustrated here).

If it was instead determined in step 510 that the received information was user-related, the routine continues to step 525 to select the next group of information, beginning with the first. In some embodiments, only a single group of information may be received, but in other situations a large number of groups of information for a large number of users may be received (e.g., from a third-party user information data source that has access to information about many users). After step 525, the routine continues to step 530 to identify user tracking information for the user corresponding to the selected information, and in step 535 stores the selected information with a mapping to that user. If no user information could be identified in step 530, in some embodiments the user-related information may instead not be stored (not illustrated here). After step 535, if it is determined in step 540 that additional groups of information remain, the routine returns to step 525.

If it was instead determined in step 510 that the received information was of another type, the routine continues to step 550 to store the other information as appropriate. After steps 520 or 550, or if it was instead determined in step 540 that there were not more groups of information, the routine continues to step 555 to make or obtain payment for the collected information as appropriate. The routine then continues to step 595 to determine whether to continue, and if so returns to step 505. If not, the routine continues to step 599 and ends.

In other embodiments, various additional types of functionality could be provided. For example, if user-related information is received interactively from a user, the routine could additionally provide other information to that user such as account information.

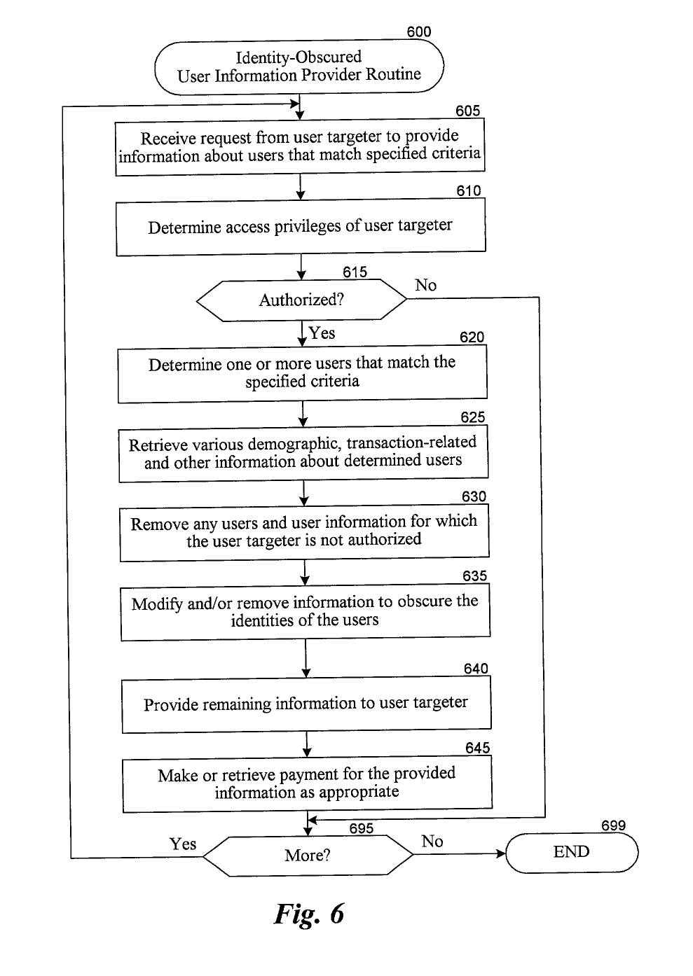

FIG. 6 is a flow diagram of an embodiment of an Identity-Obscured User Information Provider Routine 600. The routine provides identity-obscured information about users to user targeters for use in determining targeting information to be provided to users, such as for a targeting campaign. The routine begins at step 605 where a request is received from a user targeter to provide information about users that match a specified criteria. In step 610, the access privileges of the user targeter are determined, such as based on a previous registration of that user targeter and a corresponding type of access selected by that registered user targeter.

If it is determined in step 615 that the user targeter request is authorized, the routine continues to step 620 to determine one or more users that match the specified criteria. In step 625, various available demographic, transaction-related, and other information about the determined users is retrieved. In step 630, any users and/or user information types for which the user targeter is not authorized or has not requested are removed, and in step 635 any information that could be used to identify the users or that would violate any other privacy concerns are removed or modified. In step 640, the remaining identity-obscured information is then provided to the user targeter, and in step 645 payment is made or retrieved for the providing of the information as appropriate. After step 645, or if it was instead determined in step 615 that the request was not authorized, the routine continues to step 695. If it is determined in step 695 to continue, the routine returns to step 605 and if not the routine continues to step 699 and ends.

Those skilled in the art will appreciate that identity information can be obscured in various ways, such as by aggregating information about multiple users together and/or by providing detailed information about individual users that lacks identifying information. In various embodiments, such identity-obscuring of user information can be performed in manners specific to the users and/or to the user targeters, such as based on applicable legal restrictions, user preferences, a purchased level of service form a user targeter or the users, etc. In addition, in some embodiments the targeting may occur in manners that are not specific to groups of users. In particular, in some embodiment user targeters may specify additional information related to how the targeting of information is to occur, such as to target information on the basis of any combination of time of targeting, location of targeting, types of transactions during which the targeting is to occur, and/or types of users to which the targeting will occur.

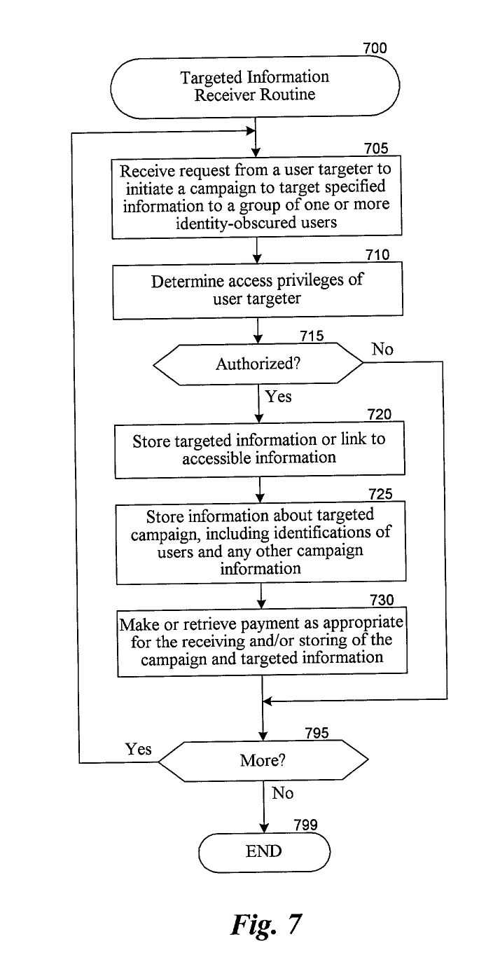

FIG. 7 is a flow diagram of an embodiment of the Targeted Information Receiver routine 700. The routine receives information from user targeters about targeting information and stores the information for use in targeted marketing to the targeted users. The routine begins at step 705 where a request is received from a user targeter to initiate a campaign to target specified information to a specified group of one or more identity-obscured users. The routine continues to step 710 to determine the access privileges of the user targeter, and if it is determined in step 715 that the request is authorized, the routine continues to step 720 to store the targeted information or a link to that information if it is accessible elsewhere. In step 725, information about the targeted campaign is stored, including identifications of the users targeted and any other relevant campaign information. In step 730, payment is made or obtained as appropriate for the receiving and/or the storing of the campaign information and the targeted information. After step 730, or if it was instead determined in step 715 that the request was not authorized, the routine continues to step 795 to determine whether to continue. If so, the routine returns to step 705, and if not the routine continues to step 799 and ends. Those skilled in the art will appreciate that campaign information can be specified in a variety of ways in various embodiments.

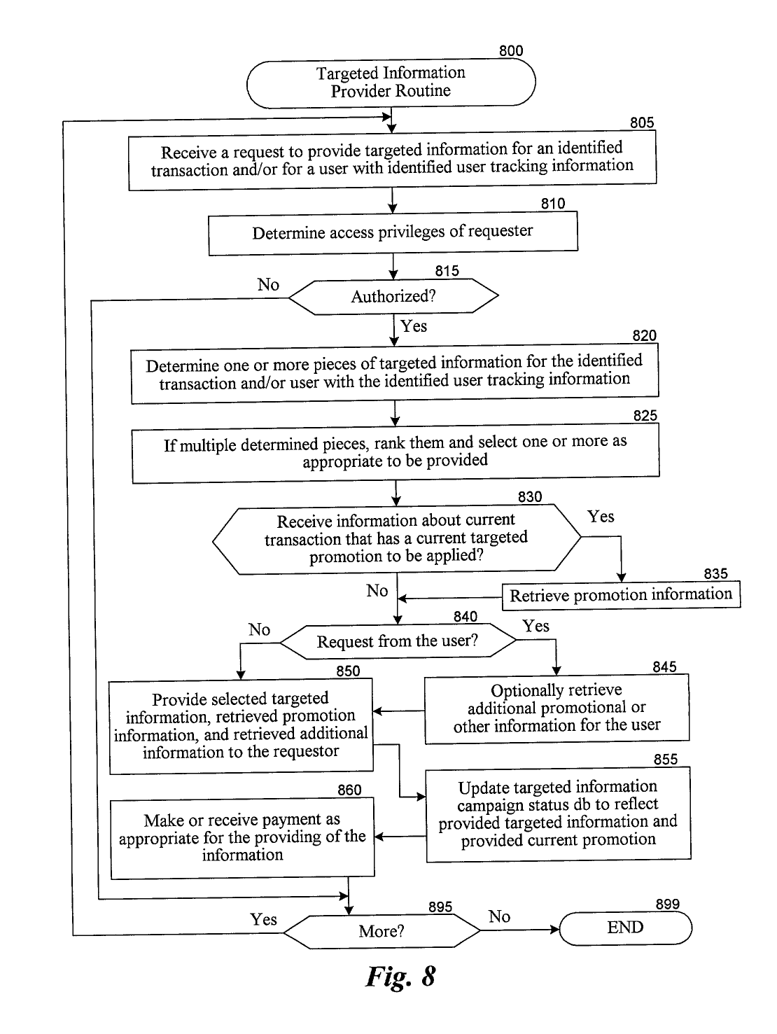

FIG. 8 is a flow diagram of an embodiment of the Targeted Information Provider Routine 800. The routine provides targeted promotion information and content to users and POS payment processors as appropriate based on a current transaction and/or a current identified user. The routine begins in step 805 where a request is received to provide targeted information for an identified transaction and/or for a user corresponding to identified user tracking information. The routine continues to step 810 to determine access privileges of the requester, and then continues to step 815 to determine whether the request is authorized. If so, the routine continues to step 820 to determine targeting information to be provided to the user. In particular, the routine identifies one or more targeting campaigns for the identified transaction and/or the user with the identified user tracking information. The routine then continues to step 825, where if multiple targeting campaigns or corresponding pieces of targeted information were identified, those possible information pieces are ranked and then one or more are selected. Those skilled in the art will appreciate that the ranking and selecting can be performed in a variety of manners, such as based on information from the requester, agreements with the user targeters who created the campaigns, user preferences, etc.

After step 825, the routine continues to step 830 to determine whether information was received in step 805 regarding a current transaction that has a corresponding current targeted promotion to be applied. In some embodiments, targeted promotions will be applied only if they have previously been identified to the user involved in the current transaction, and in other embodiments such a restriction may not be used. If there is a corresponding current targeted promotion to be applied, the routine continues to step 835 to retrieve the promotion information. After step 835, or if it was instead determined in step 830 that there was no current targeted promotion, the routine continues to step 840 to determine whether the request in step 805 was received from a user, such as to interactively provide various types of targeted promotions or other targeted content. If so, the routine continues to step 845 to optionally retrieve additional types of promotional or other information to be provided to the user, such as user account status information or various user-selectable options.

After step 845, or if it was instead determined in step 840 that the request was not from the user, the routine continues to step 850 to provide to the requester the selected targeted information, any retrieved promotional information, and any retrieved additional information. The routine then continues to step 855 to update the targeted information campaign status information to reflect the providing of the targeting information and optionally the providing of the current promotion information. After step 855, the routine continues to step 860 to make or obtain payment as appropriate for the providing of the various types of information. After step 860, or if it was instead determined in step 815 that the request was not authorized, the routine continues to step 895 to determine whether to continue. If so, the routine returns to step 805, and if not the routine continues to step 899 and ends. While not illustrated here, in other embodiments the routine may additionally provide other functionality, such as to direct a device at the POS location to query the user regarding dynamically registering at the device.

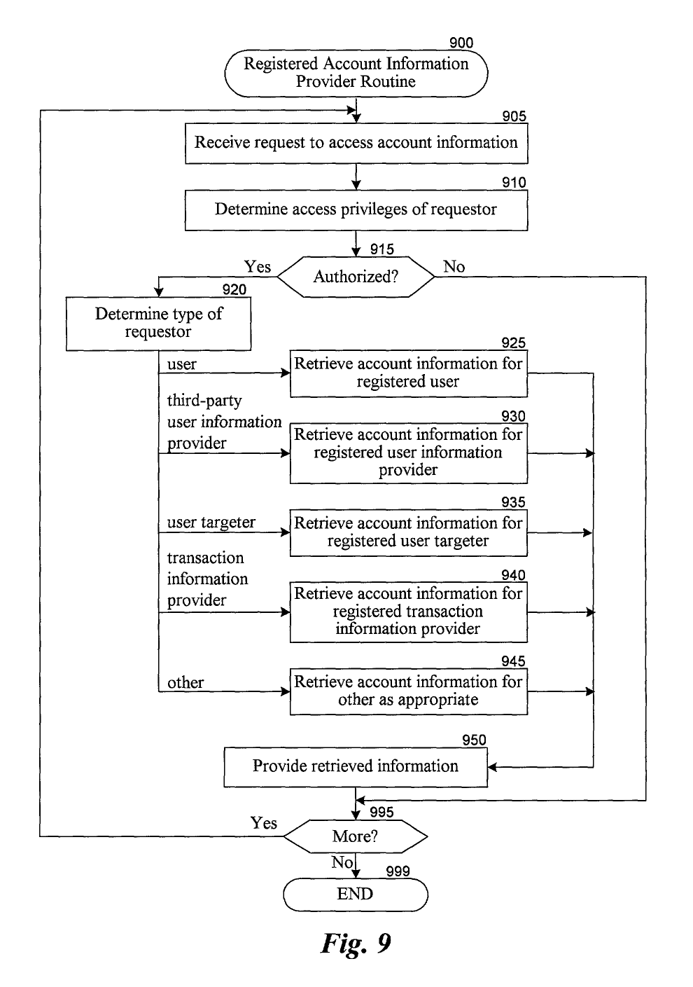

FIG. 9 is a flow diagram of an embodiment of a Registered Account Information Provider Routine 900. The routine receives requests from registered entities to access their account information, and provides the information as appropriate. The routine begins in step 905 where a request is received to access account information. The routine continues to step 910 to determine the access privileges of the requester. If it is determined at step 915 that the request is authorized, the routine continues to step 920 to determine the type of requester. If the requester is of one of the various types of “user”, “third-party user information provider”, “user targeter”, “transaction information provider”, or “other”, the routine continues respectively to steps 925, 930, 935, 940, or 945. In each of steps 925-945, account information for the respective type of user is retrieved, and after any of those steps the routine continues to step 950 to provide the retrieved information to the requester. After step 950, or if it was instead determined in step 915 that the request was not authorized, the routine continues to step 995 to determine whether to continue. If so, the routine returns to step 905, and if not the routine continues to step 999 and ends. In other embodiments, this or another routine could additionally allow one or more of the types of requesters to open accounts or modify existing account information.

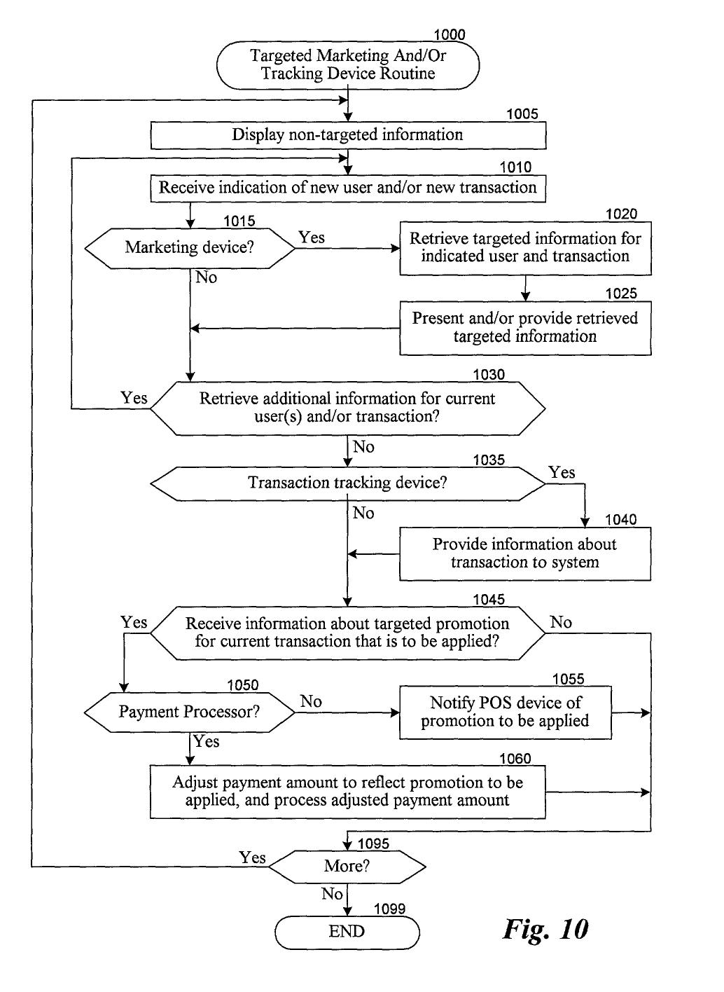

FIG. 10 is a flow diagram of an embodiment of the Targeted Marketing And/Or Tracking Device Routine 1000. The routine in the illustrated embodiment operates in conjunction with a corresponding POS device to receive information about a current user and/or current transaction, to communicate with the PPTMT system to receive information about targeted promotions and/or targeted content, and to apply the information from the PPTMT system to the current transaction and/or provide the information to the user.

The routine begins in step 1005 where the user interface is initialized and non-targeted information is displayed. In step 1010, the routine receives an indication of a new transaction beginning and/or of a new user that is accessing the device. Such information can be received in a variety of ways, such as from an associated POS device or instead directly from the user and/or an operator of the device (e.g., a clerk in a retail location). The routine continues to step 1015 to determine whether the current device is acting as a device to present targeted marketing information to users, and if so continues to step 1020 to retrieve targeted information for the indicated user and/or transaction from the PPTMT system. After step 1020, the routine continues to step 1025 to present and/or provide the retrieved targeted information to the user. After step 1025, or if it was instead determined in step 1015 that the device is not acting to provide targeted marketing information, the routine continues to step 1030 to determine whether to retrieve additional information about current users and/or the current transaction, and if so returns to step 1010.

If not, the routine continues to step 1035 to determine whether the device is currently operating as a transaction tracking device to provide information about current transactions to the PPTMT system to assist in later targeting. If so, the routine continues to step 1040 to provide information about the current transaction to the system. After step 1040, or if it was instead determined in step 1035 that the device was not acting as a transaction tracking device, the routine continues to step 1045 to determine whether information was received about a targeted promotion for the current transaction that is to be applied. If so, the routine continues to step 1050 to determine whether the device is providing payment processing functionality for the transaction (e.g., in conjunction with the PPTMT system). If not, the routine continues to step 1055 to notify the POS device and/or other payment processor of the promotion to be applied, and if so the routine continues to step 1060 to adjust the payment amount to reflect the promotion to be applied before processing the adjusted payment amount. After steps 1055 or 1060, or if it was instead determined in step 1045 that there is not a current targeted promotion, the routine continues to step 1095 to determine whether to continue. If so, the routine returns to step 1005, and if not the routine continues to step 1099 and ends.

Those skilled in the art will also appreciate that in some embodiments the functionality provided by the routines discussed above may be provided in alternative ways, such as being split among more routines or consolidated into less routines. Similarly, in some embodiments illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel) and/or in a particular order, those skilled in the art will appreciate that in other embodiments the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some embodiments illustrated data structures may store more or less information than is described, such as when other illustrated data structures instead lack or include such information respectively, or when the amount or types of information that is stored is altered.

From the foregoing it will be appreciated that, although specific embodiments have been described herein for purposes of illustration, various modifications may be made without deviating from the spirit and scope of the invention. Accordingly, the invention is not limited except as by the appended claims and the elements recited therein. In addition, while certain aspects of the invention are presented below in certain claim forms, the inventors contemplate the various aspects of the invention in any available claim form. For example, while only some aspects of the invention may currently be recited as being embodied in a computer-readable medium, other aspects may likewise be so embodied.

What is claimed is:

1. A computer-implemented method for a privacy-protecting service to provide marketing promotions from retailers to targeted individuals in a manner that protects identities of the individuals from the retailers, the method comprising:
for each of multiple individuals that are potential recipients of targeted marketing promotions, receiving information about previous transactions involving the individual from one or more of multiple third-party information sources that are distinct from the individuals and the privacy-protecting service;
determining individuals to be targeted by marketing promotions by, for each of multiple targeting retailers desiring to target marketing promotions to appropriate individuals,
determining based at least in part on the received previous transaction information a group of multiple individuals that were each involved in previous transactions that match specified criteria for the targeting retailer;
providing information to the targeting retailer about the determined group in such a manner as to obscure the identities of the individuals in the group; and
receiving an instruction from the targeting retailer to target a specified marketing promotion to the individuals in the group; and
providing marketing promotions to targeted individuals by, for each of multiple transaction retailers involved in transactions with individuals,
receiving information about a current transaction that is occurring between a transaction retailer and an individual; and
if it is determined that the individual involved in the current transaction is part of a group to which a marketing promotion has been targeted by a targeting retailer unrelated to the transaction retailer, providing information about that targeted marketing promotion from the targeting retailer for presentation to that individual on a device at a location of the current transaction, so that while engaged in a transaction with a retailer an individual can receive a marketing promotion targeted by another retailer in a manner that protects the identity of the individual.

2. The method of claim 1 wherein each marketing promotion from a targeting retailer includes a discount available to targeted individuals if they are involved in a specified transaction with that targeting retailer, and including, after presenting information to a first targeted individual about a marketing promotion from a first targeting retailer that includes a first discount for a first transaction with that first targeting retailer, providing the first discount to the first targeted individual by:
receiving information about a current transaction that is occurring between a transaction retailer and an individual; and
when it is determined that the individual is the first targeted individual and that the transaction retailer is the first targeting retailer and that the current transaction is the first transaction, providing the first discount for the current transaction.

3. The method of claim 2 wherein the privacy-protecting service provides a payment processing service to the first targeting retailer, and wherein the providing of the first discount for the current transaction includes adjusting an amount of the payment to be processed to reflect the first discount.

4. The method of claim 1 wherein the devices at the locations of current transactions are targeted marketing devices that each include a display, and wherein the providing of the information about a targeted marketing promotion from a targeting retailer to an individual includes presenting an advertisement including that targeted marketing promotion information to that individual on the targeted marketing device at the current transaction location.

5. The method of claim 4 wherein each of the targeted marketing devices are associated with a single nearby Point-Of-Sale device that process transactions.

6. The method of claim 4 wherein each of the targeted marketing devices are also tracking devices that send information about current transactions that are occurring to the privacy-protecting service, and wherein the sent information for at least some current transactions that are each occurring between a transaction retailer and an individual includes information received from the individual by the targeted marketing and tracking device for that current transaction with which the privacy-protecting service can identify the individual, such that the information received by the privacy-protecting service for those current transactions includes the information received from those individuals.

7. The method of claim 4 including, when an individual to which a targeted marketing device presents an advertisement is not a registered user of the privacy-protecting service, presenting additional information to the individual on the targeted marketing device to prompt the individual to register with the privacy-protecting service.

8. The method of claim 1 wherein the determining of a group of multiple individuals involved in previous transactions that match specified criteria for a targeting retailer includes receiving a request from that targeting retailer to supply information about individuals matching that specified criteria and retrieving in response transaction information that matches that specified criteria, and including modifying the retrieved transaction information so as to obscure the identities of the individuals to which the retrieved transaction information corresponds before the providing of that modified transaction information to that targeting retailer.

9. The method of claim 8 wherein the modifying of the retrieved transaction information so as to obscure the identities of the individuals to which the retrieved transaction information corresponds includes aggregating information for multiple individuals.

10. The method of claim 1 including receiving demographic information for at least some of the multiple individuals that are potential recipients of targeted marketing promotions, wherein at least some of the specified criteria for targeting retailers include criteria parameters related to transaction information and criteria parameters related to demographic information, and wherein the determining of the groups of multiple individuals that match those specified criteria is further based at least in part on the received demographic information.

11. The method of claim 1 including:
receiving instructions from targeting retailers to target specified marketing promotions to specified types of transactions; and
after receiving information about a current transaction that is occurring between a transaction retailer and an individual, if it is determined that the current transaction is of a specified type to which a marketing promotion has been targeted by a targeting retailer unrelated to the transaction retailer, providing information about that targeted marketing promotion from the targeting retailer for presentation to that individual on a device at a location of the current transaction.

12. The method of claim 1 including:
after receiving information about a current transaction that is occurring between a transaction retailer and an individual, determining whether the transactions in which that individual has been involved now match a previously specified criteria for a targeting retailer; and
if it is determined that the transactions in which that individual has been involved now match a previously specified criteria for a targeting retailer, adding that individual to the group of individuals to which that targeting retailer is targeting a specified marketing promotion.

13. The method of claim 1 including further providing marketing promotions to targeted individuals by receiving an indication of an individual who is not involved in a current transaction being accessible at a device and providing to that device information about a marketing promotion targeted to that individual for presentation to that individual.

14. The method of claim 1 including receiving a request from a targeting retailer to provide information related to a specified marketing promotion that is targeted to a group of multiple individuals, and in response providing summaries of how many of the multiple individuals have received the specified marketing promotion and of how many of the multiple individuals have received benefits provided by the specified marketing promotion.

15. The method of claim 1 wherein the transaction retailers are members of an affiliate network sponsored by the privacy-protecting service.

16. A computer-implemented method for targeting information to users in a manner that protects privacy of the users, the method comprising:
receiving an indication from a user targeter of a specified criteria;
determining one or more users that have associated information that matches the specified criteria;
selecting at least some of the associated information for each of the determined users;
after obscuring sensitive information in the selected information, providing the resulting selected information to the user targeter; and
if the user targeter indicates to target specified information to the determined users based on the provided information, storing an indication of the targeting of the specified information to the determined users so that the specified information can later be provided to one or more of the determined users.

17. The method of claim 16 wherein the specified criteria is based at least in part on previous transactions, and wherein the associated information of the determined users relates to previous transactions involving those users.

18. The method of claim 17 wherein the associated information relating to previous transactions involving the determined users is received from others involved in those transactions.

19. The method of claim 17 wherein the associated information relating to previous transactions involving the determined users is received from third-parties to those transactions.

20. The method of claim 16 wherein the specified criteria is based at least in part on demographic information, and wherein the associated information of the determined users relates to demographic information for those users.

21. The method of claim 20 wherein the associated information relating to demographic information for the determined users is received from the determined users.

22. The method of claim 20 wherein the associated information relating to demographic information for the determined users is received from information sources other than the determined users.

23. The method of claim 16 wherein the associated information for each of the determined users that is selected and/or the sensitive information in the selected information that is obscured is based at least in part on the received indication from the user targeter.

24. The method of claim 16 wherein the associated information for each of the determined users that is selected and/or the sensitive information in the selected information that is obscured is based at least in part on a level of service purchased by the user targeter.

25. The method of claim 16 wherein the associated information for each of the determined users that is selected and/or the sensitive information in the selected information that is obscured is based at least in part on preferences of the determined users.

26. The method of claim 16 wherein the associated information for each of the determined users that is selected and/or the sensitive information in the selected information that is obscured is based at least in part on levels of service purchased by the determined users.

27. The method of claim 16 wherein the selecting of the associated information for the determined users includes selecting all of that associated information.

28. The method of claim 16 wherein the obscuring of the sensitive information includes removing the sensitive information.

29. The method of claim 16 wherein the obscuring of the sensitive information includes removing any information from which identities of the determined users could be determined.

30. The method of claim 16 wherein the obscuring of the sensitive information includes removing any information from which the determined users could be contacted.

31. The method of claim 16 wherein when the selected information does not include sensitive information, the obscuring of the sensitive information in the selected information does not modify the selected information.

32. The method of claim 16 wherein the specified information is information related to a marketing promotion.

33. The method of claim 16 wherein the specified information is content for presentation to the determined users.

34. The method of claim 16 including, before the determining of the users that have associated information that matches the specified criteria, receiving the associated information from third-party information providers.

35. The method of claim 16 including, after the storing of the indication of the targeting of the specified information to the determined users, receiving an indication of one of the determined users who is accessible via a device and providing the specified information to that device.

36. The method of claim 35 wherein the received indication indicates that the one determined user is involved in a transaction at a Point-Of-Sale retail location at which the device is present.

37. The method of claim 35 wherein the received indication is a request from the one determined user to provide targeted information.

38. The method of claim 35 wherein the received indication is based on stored contact information for the one determined user that indicates one or more devices of the user.

39. The method of claim 35 wherein the received indication is based on a temporary presence of the one determined user at a device from which many users may be accessible at different times.

40. The method of claim 35 wherein the received indication is based on the one determined user providing payment information specific to the user.

41. The method of claim 35 wherein the received indication is based on the one determined user providing identification information specific to the user.

42. The method of claim 35 wherein the providing of the specified information to the device includes presenting the specified information on the device.

43. The method of claim 35 wherein the providing of the specified information to the device includes storing the specified information on the device for later retrieval by the one determined user.

44. The method of claim 35 wherein the providing of the specified information to the device includes transmitting the specified information from the device to another device specific to the one determined user.

45. The method of claim 35 wherein the indication to target specified information to the determined users includes an indication related to timing of the providing of the specified information to the determined users.

46. The method of claim 45 wherein the indicated timing of the providing of the specified information to the determined users is based at least in part on one or more of a time of the providing, a location of the determined user, and a current transaction in which the determined user is involved.

47. The method of claim 35 including prompting the determined user via the device to provide additional information about the determined user.

48. The method of claim 35 including prompting the determined user via the device to provide permission to provide targeted information to the determined user.

49. The method of claim 16 wherein the specified information is for a marketing promotion including a benefit to the determined users, and including, after the storing of the indication of the targeting of the specified information to the determined users, providing the benefit to at least one of the determined users.

50. The method of claim 49 including receiving an indication that one of the determined users is involved in a transaction related to the marketing promotion, and wherein the providing of the benefit is part of the transaction.

51. The method of claim 49 wherein the providing of the benefit to the one determined user is performed only after information about the marketing promotion is provided to the one determined user.

52. The method of claim 16 including providing information to the user targeter that indicates a rate of success of providing the specified information to the determined users.

53. The method of claim 16 including providing information to the user targeter that indicates a rate of use of the specified information by the determined users that have received that specified information.

54. A computer-readable medium whose contents cause a computing device to target information to users in a manner that protects privacy of the users, by performing a method comprising:
receiving information about multiple users from one or more information sources;
receiving an indication from a user targeter of a specified criteria;
after obscuring sensitive information, providing resulting information to the user targeter about one or more of the multiple users that were determined to match the specified criteria; and
after the user targeter indicates to target specified information to the determined users based on the provided information, providing the specified information to at least one of the determined users.

55. The computer-readable medium of claim 54 wherein the specified information is information related to a marketing promotion, and wherein the providing of the specified information to at least one of the determined users includes presenting the specified information to the one determined user on a device at a Point-Of-Sale location at which the one determined user is involved in a transaction distinct from a transaction to which the marketing promotion applies.

56. The computer-readable medium of claim 54 wherein the computer-readable medium is a memory of a computing device.

57. The computer-readable medium of claim 54 wherein the computer-readable medium is a data transmission medium transmitting a generated data signal containing the contents.

58. The computer-readable medium of claim 54 wherein the contents are instructions that when executed cause the computing device to perform the method.

59. A computing device for targeting information to users in a manner that protects privacy of the users, comprising:
an information collector component that is capable of receiving information about multiple users from one or more information sources;
a user information provider component that is capable of receiving an indication from a user targeter of a specified criteria, of determining one or more of the multiple users whose associated information matches the specified criteria, and of providing information to the user targeter about the determined users so as to obscure sensitive information about the determined users; and
a targeted information provider component that is capable of, after the user targeter indicates to target specified information to the determined users based on the provided information, providing the specified information to at least one of the determined users.

60. The computing device of claim 59 wherein the information collector component, the user information provider component, and the targeted information provider component are executing in memory of the computing device.

61. A computing device for targeting information to users in a manner that protects privacy of the users, comprising:
means for receiving information about multiple users from one or more information sources;
means for receiving an indication from a user targeter of a specified criteria;
means for determining one or more of the multiple users whose associated information matches the specified criteria and for providing information to the user targeter about the determined users in a manner that obscures sensitive information about the determined users; and
means for, after the user targeter indicates to target specified information to the determined users based on the provided information, providing the specified information to at least one of the determined users.

62. A method in a computing device for providing information to targeted users, the method comprising:
identifying tracking information for a user involved in a current transaction;
receiving information that is targeted to the user based on factors other than the current transaction; and
presenting the received information to the user before completion of the current transaction.

63. The method of claim 62 wherein the identifying of the tracking information for the user includes receiving payment information for the current transaction from the user.

64. The method of claim 62 wherein the received information is for a marketing promotion for a distinct transaction with a retailer distinct from a current retailer with whom the current transaction is occurring.

65. The method of claim 62 including prompting the user for permission to provide targeted information to the user.

66. The method of claim 62 including prompting the user to register with a service providing privacy-protected targeted marketing.

67. A computing device for providing information to targeted users, comprising:
a tracking component that is capable of identifying information for a user involved in a transaction;
an information receiver component that is capable of receiving information that is targeted to the user based on factors other than the transaction; and
a provider component that is capable of providing the received information to the user as part of the transaction.
